(19) United States
(12) Patent Application Publication
(10) Pub. No.: US 2009/0207035 A1
(43) Pub. Date: Aug. 20, 2009

(54) Electrical power tools

(75) Inventors: Masahiro Watanabe, Anjo-shi (JP); Jiro Suzuki, Anjo-shi (JP); Jun Ota, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, ANJO-SHI (JP)

(21) Appl. No.: 12/320,815

(22) Filed: Feb. 5, 2009

(30) Foreign Application Priority Data
Feb. 15, 2008 (JP) 2008-034414

(51) Int. Cl. G08B 21/00

(52) U.S. Cl. 340/657

(57) ABSTRACT

An electrical power tool may include a housing, a rotating tool that is rotatably attached to the housing, a motor that is positioned in the housing and is capable of rotating the rotating tool, a manipulating portion that is attached to the housing, and an indicator device that is disposed in the housing and is capable of indicating a condition of the electrical power tool. The manipulating portion is positioned to substantially cover the indicator device. The manipulating portion is constructed such that light emitted from the indicator device can be transmitted therethrough.

This application claims priority to Japanese patent application serial number 2008-034414, the contents of which are incorporated herein by reference.

### BACKGROUND OF THE INVENTION

1. Field of the Invention

The present invention relates to electrical power tools. More particularly, the present invention relates to electrical power tools that are constructed such that manipulating portions attached to housings are operated to drive motors in the housings, thereby operating rotating tools rotatably attached to the housings.

2. Description of Related Art

For example, as shown in FIG. 5, an electrical disk grinder 100 (an electrical power tool) is already known. In the electrical disk grinder 100, a load indicator portion 120 is disposed on an upper surface of a housing 101. The load indicator portion 120 is capable of indicating load conditions of the disk grinder 100. The load indicator portion 120 is constructed of a plurality of indicator lights, a light case that houses the indicator lights therein, a light cover 122 that covers the indicator lights, and other components. The load indicator portion 120 is positioned in the housing 101 such that the light cover 122 can form a portion of the upper surface of the housing 101.

As described above, in the disk grinder 100, the load indicator portion 120 is constructed of many components (i.e., the indicator lights, the light case, the light cover 122 and other components). Therefore, for example, when additional indicator lights should be provided to the disk grinder 100, it is necessary to additionally provide a light case and a light cover on the housing 101. As a result, in some cases, the housing 101 cannot be used as is (i.e., without changing design or size thereof). In addition, the electrical disk grinder 100 needs a large number of components.

Such an electrical power tool is taught, for example, by Japanese Laid-Open Utility Model Publication Number 61-187659.

### BRIEF SUMMARY OF THE INVENTION

In one aspect of the present invention, an electrical power tool may include a housing, a rotating tool that is rotatably attached to the housing, a motor that is positioned in the housing and is capable of rotating the rotating tool, a manipulating portion that is attached to the housing, and an indicator device that is disposed in the housing and is capable of indicating a condition of the electrical power tool. The manipulating portion is positioned to substantially cover the indicator device. The manipulating portion is constructed such that light emitted from the indicator device can be transmitted therethrough.

According to this aspect, the indicator device indicating the conditions of the electrical power tool can be seen through the manipulating portion. Therefore, it is not necessary to provide a window (a light cover) or other such members to the housing in order to see the indicator device therethrough. As a result, even when additional indicator devices should be provided to the electrical power tool, the housing can be used as is (i.e., without changing design or size thereof). In addition, the number of components of the electrical power tool can be effectively reduced.

Optionally, the manipulating portion and the indicator device can be attached to a circuit board of a circuit device for controlling the motor. The manipulating portion may preferably be partially projected from a slot that is formed in the housing. Further, the manipulating portion may preferably be rotatably attached to the circuit board.

Other objects, features and advantages of the present invention will be readily understood after reading the following detailed description together with the accompanying drawings and the claims.

### BRIEF DESCRIPTION OF THE DRAWINGS

FIG. 1 is a side view of an electrical disk grinder according to a representative embodiment of the present invention;

FIG. 2 is a longitudinal cross-sectional view of the electrical disk grinder;

FIG. 3(A) is a side view of a circuit device that is capable of controlling a motor;

FIG. 3(B) is a view viewed from a direction shown by arrows B-B of FIG. 3(A);

FIG. 3(C) is a view viewed from a direction shown by an arrow C of FIG. 3(A);

FIG. 4 is a circuit diagram, which illustrates a circuit of the electrical disk grinder; and

FIG. 5 is a perspective view of a conventional electrical disk grinder.

### DETAILED DESCRIPTION OF THE INVENTION

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

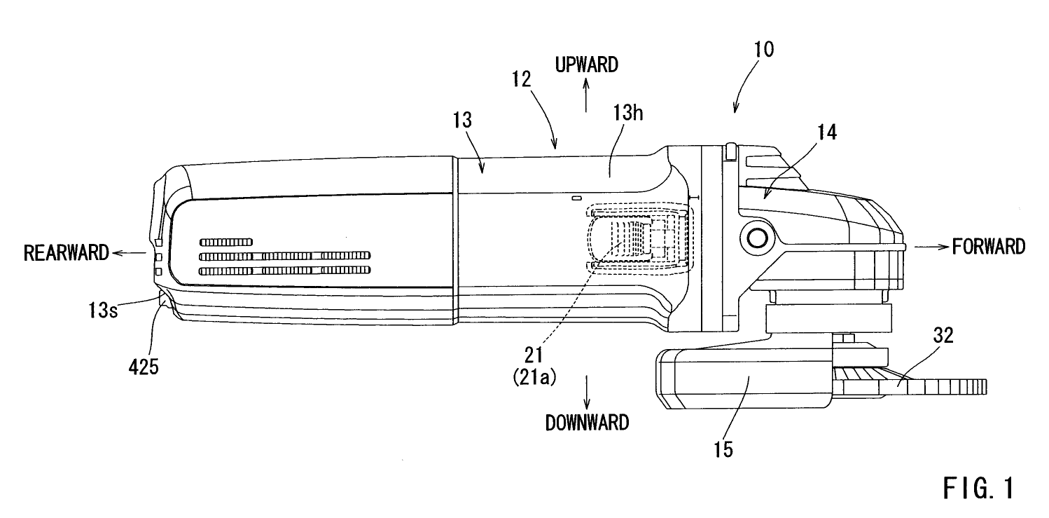

A detailed representative embodiment of the present invention will be described with reference FIGS. 1 to 4. In the embodiment, an electrical disk grinder 10 (which will be simply referred to as a disk grinder 10) is exemplified as an electrical power tool. Further, forward and rearward, rightward and leftward, and upward and downward in the drawings respectively correspond to forward and rearward, rightward and leftward, and upward and downward of the disk grinder 10.

As shown in FIG. 1, the disk grinder 10 includes a housing 12 that is composed of a motor housing 13 and a gear housing 14. The motor housing 13 is formed to a cylindrical shape and has a hand grip 13h that is formed in a front half portion thereof. Further, attached to a left side surface of the hand grip 13h is a switch lever 21a of an electric power switch 21 of the disk grinder 10. Because the switch lever 21a is positioned on the hand grip 13h, a user can easily manipulate the switch lever 21a with his/her thumb while gripping the hand grip 13h, so as to turn on and off the electric power switch 21.

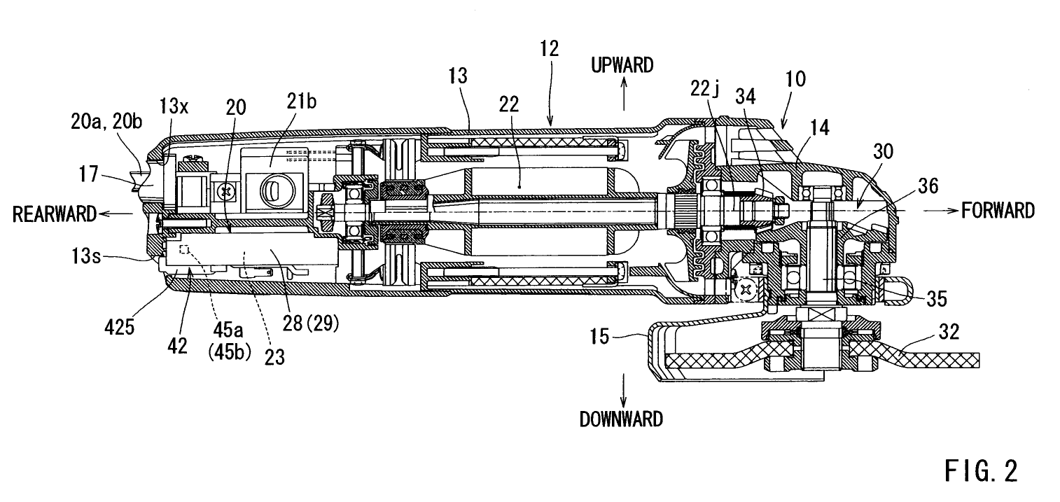

As shown in FIG. 2, a motor 22 is positioned in the motor housing 13 while a rotational axis of the motor 22 is aligned with a central axis of the motor housing 13.

As shown in FIG. 2, the gear housing 14 is coupled to a front end portion of the motor housing 13. A power transmission mechanism 30 is positioned in the gear housing 14. The power transmission mechanism 30 is arranged and constructed to transmit a rotational force of the motor 22 to a grinding disk 32 (a rotating tool).

As shown in FIG. 2, the power transmission mechanism 30 is composed of a first bevel gear 34 of small diameter, a main shaft 35 and a second bevel gear 36 of large diameter. The first bevel gear 34 is fixedly connected to a front end of an output shaft 22j of the motor 22. The main shaft 35 is positioned at right angles to the output shaft 22j of the motor 22. The second bevel gear 36 is fixedly connected to the main shaft 35 while meshing with the first bevel gear 34.

The main shaft 35 is arranged and constructed such that a lower end portion thereof is downwardly projected from a lower surface of the gear housing 14. The grinding disk 32 is axially aligned with and fixedly connected to the projected lower end portion of the main shaft 35. Further, a semicircular cover 15 is attached to the lower surface of the gear housing 14, so as to substantially cover a rear half portion (a portion adjacent to the hand grip 13h of the motor housing 13) of the grinding disk 32.

As shown in FIG. 2, a circuit device 20 that is capable of controlling the motor 22 is positioned in the motor housing 13. The circuit device 20 may preferably be positioned behind the motor 22.

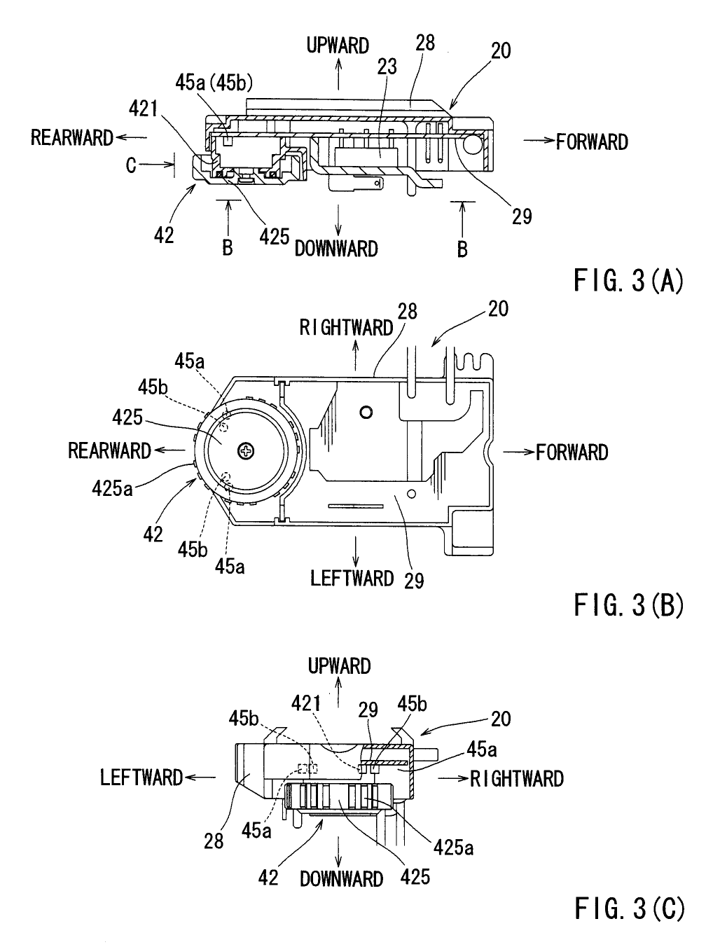

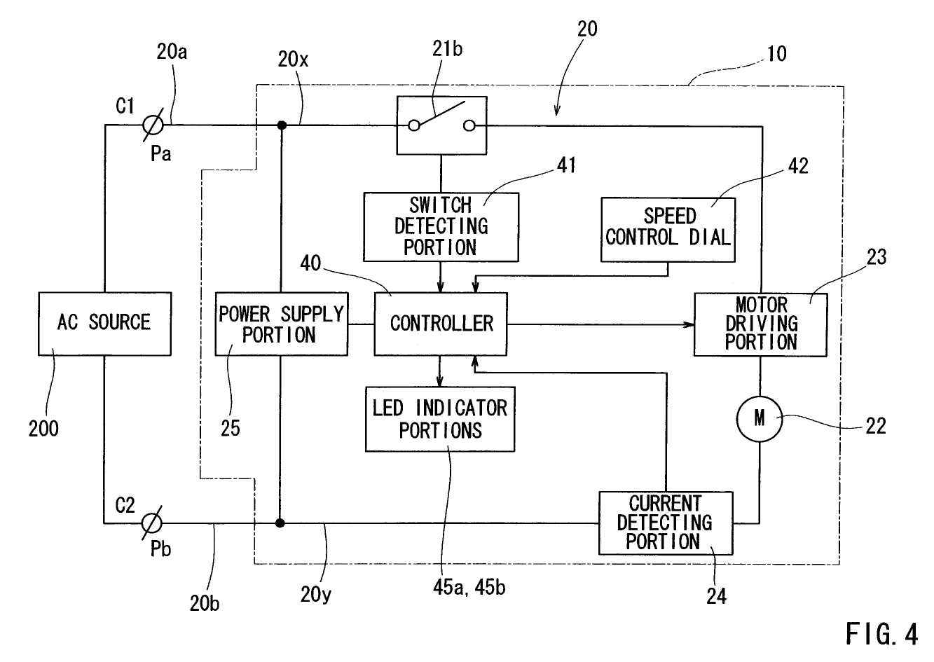

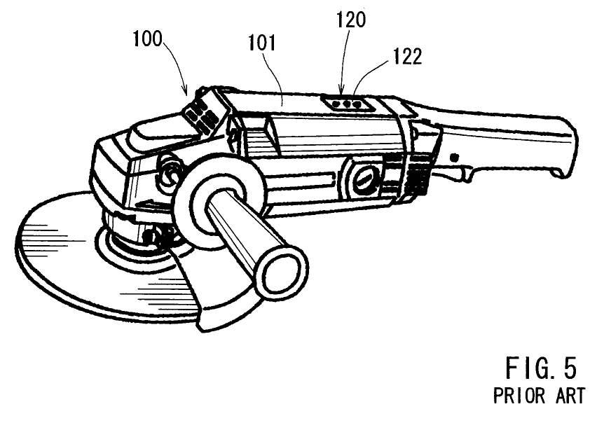

The circuit device 20 is composed of a circuit board 29 (FIG. 3), a switch main portion 21b of the electric power switch 21 (FIGS. 2 and 4), a motor driving portion 23, a current detecting portion 24, and power supply cables 20a and 20b. The circuit board 29 (FIG. 3) includes a controller 40, a power supply portion 25 of the controller 40, a switch detecting portion 41, a speed setting dial 42 (a manipulating portion), LED indicator portions 45a and 45b (an indicator device) and other components that are attached thereto. As shown in FIG. 2, the circuit board 29 is attached to an inner wall surface of the motor housing 13 via a circuit board support 28 having a substantially rectangular shape. The power supply cables 20a and 20b are arranged and constructed so as to supply electric power to power lines 20x and 20y of the circuit device 20.

The electric power switch 21 is composed of the switch lever 21a and the switch main portion 21b. As previously described, the switch lever 21a is attached to the left side surface of the hand grip 13h. Conversely, the switch main portion 21b is contained in the circuit device 20. The switch main portion 21b is arranged and constructed to be closed and opened when the switch lever 21a is moved, so as to turn on and off the electric power switch 21.

As shown in FIG. 2, the power supply cables 20a and 20b are respectively jacketed by sealing members 17 and are inserted into cable insertion holes 13x that are formed in a rear end upper portion of the motor housing 13. The power supply cables 20a and 20b have conductive connection parts that are provided to proximal (inner) end portions thereof. As shown in FIG. 4, the conductive connection parts of the power supply cable 20a and 20b are respectively connected to the power lines 20x and 20y of the circuit device 20 in the motor housing 13. Further, as shown in FIG. 4, the power supply cables 20a and 20b have plugs Pa and Pb that are provided to distal (outer) end portions thereof. The plugs Pa and Pb are arranged and constructed to be connected to plug sockets C1 and C2 of an AC (alternating-current) source 200.

As shown in FIG. 4, the switch main portion 21b of the electric power switch 21, the motor driving portion 23, the motor 22 and the current detecting portion 24 are connected to the power lines 20x and 20y of the circuit device 20 in series. Further, the power supply portion 25 of the controller 40 is connected to the power lines 20x and 20y of the circuit device 20, so as to be in parallel with the switch main portion 21b of the electric power switch 21, the motor driving portion 23, the motor 22 and the current detecting portion 24.

As shown in FIG. 4, the controller 40 is arranged and constructed to transmit control signals to the motor driving portion 23 in response to signals from the switch detecting portion 41 and the speed setting dial 42. For example, when the switch main portion 21b of the electric power switch 21 is closed and a corresponding ON-signal is transmitted from the switch detecting portion 41 to the controller 40, the controller 40 transmits the control signal (a motor actuating signal) to the motor driving portion 23. The motor driving portion 23 performs phase-control of a triac and other elements in response to the control signal (the motor actuating signal) from the controller 40, thereby actuating or driving the motor 22. Conversely, when the switch main portion 21b is opened and a corresponding OFF-signal is transmitted to the controller 40 from the switch detecting portion 41, the controller 40 transmits the control signal (a motor deactuating signal) to the motor driving portion 23. The motor driving portion 23 deactuates or stops the motor 22 in response to the control signal (the motor deactuating signal) from the controller 40.

Further, as shown in FIG. 4, when signals are transmitted from the speed setting dial 42 to the controller 40, the controller 40 transmits the corresponding control signals to the motor driving portion 23, so that the motor 22 can be rotated at predetermined rotation speeds.

Further, the controller 40 is connected to the power supply portion 25, so as to detect voltages between the power lines 20x and 20y. Based on the detected voltages, the controller 40 can determine as to whether the plugs Pa and Pb are connected to the plug sockets C1 and C2, so as to transmit representative ON/OFF signals to the LED indicator portions 45a (which are preferably composed of, for example, two green LEDs). When the ON signal is transmitted to the LED indicator portions 45a, the LED indicator portions 45a can emit light so as to indicate that the disk grinder 10 is in a power supplied condition. In addition, the controller 40 can determine as to whether the disk grinder 10 is in a reactuate preventive condition, so as to transmit representative ON/OFF signals to the LED indicator portions 45b (which are preferably composed of, for example, two red blinker LEDs). When the ON signal is transmitted to the LED indicator portions 45b, the LED indicator portions 45b can emit light so as to indicate that the disk grinder 10 is in the reactuate preventive condition. Further, the reactuate preventive condition can be obtained when the plugs Pa and Pb are removed from the plug sockets C1 and C2 while the electric power switch 21 is turned on, for example, because of a power cut. In this condition, even if the plugs Pa and Pb are connected to the plug sockets C1 and C2 again while the electric power switch 21 is turned on, the motor actuating signal cannot be transmitted to the motor driving portion 23 form the controller 40. As a result, the motor 22 cannot be actuated or driven.

As shown in FIG. 3(A), the speed setting dial 42 is composed of an inner cylindrical fixture portion 421 and an outer disk-shaped rotatable portion 425. The rotatable portion 425 is attached to a lower end of the fixture portion 421. In addition, the rotatable portion 425 is coaxially positioned with respect to the fixture portion 421 and is capable of rotating about an axis. The speed setting dial 42 is attached to the circuit board 29 such that the axis of the fixture portion 421 and the rotatable portion 425 is positioned perpendicular to a surface of the circuit board 29. As will be appreciated, the speed setting dial 42 is constructed to set rotation speeds of the motor 22 within a predetermined range depending upon a rotation angle of the rotatable portion 425 relative to the fixture portion 421.

As shown in FIGS. 1 and 2, a laterally (transversely) elongated rectangular slot 13s is formed in a rear end lower portion of the motor housing 13. The speed setting dial 42 may preferably be positioned such that an outer peripheral surface of the rotatable portion 425 can be partially projected from the slot 13s, so that the rotatable portion 425 can be manipulated from the outside of the motor housing 13. As shown in FIGS. 3(B) and 3(C), a plurality of ribs 425a are circumferentially formed in the outer peripheral surface of the rotatable portion 425. Therefore, the rotatable portion 425 can be easily rotated by tangentially pressing the outer peripheral surface thereof by fingers. In addition, the outer peripheral surface of the rotatable portion 425 are circumferentially calibrated, so that the rotation speeds of the motor 22 can be easily and quickly set to the predetermined rotation speeds.

The rotatable portion 425 of the speed setting dial 42 may preferably be formed from light transmissive (transparent) materials. As shown in FIG. 3(B), the LED indicator portions 45a and 45b may preferably be disposed on the circuit board 29 so as to substantially be positioned inside the rotatable portion 425 (i.e., so as to substantially be covered by the rotatable portion 425). Also, as shown in FIG. 3(B), the LED indicator portions 45a and 45b may preferably be disposed on the circuit board 29 so as to be positioned laterally outside the fixture portion 421. That is, the LED indicator portions 45a and 45b may preferably be positioned inside the speed setting dial 42. Thus, the LED indicator portions 45a and 45b is positioned such that the light emitted therefrom and transferred through the rotatable portion 425 can be clearly seen via the slot 13s formed in the motor housing 13.

When the disk grinder 10 is in the power supplied condition and the reactuate preventive condition, the LED indicator portions 45a and 45b emit the light, so that the rotatable portion 425 of the speed setting dial 42 can be lightened by the emitted light. Thus, the conditions of the disk grinder 10 can be indicated.

As described above, the speed setting dial 42 is positioned to substantially encircle or cover the LED indicator portions 45a and 45b. In addition, the speed setting dial 42 is transparent such that the light emitted from the LED indicator portions 45a and 45b can be transmitted therethrough. Therefore, the light emitted from the LED indicator portions 45a and 45b (the indicator device) indicating the conditions of the disk grinder 10 can be seen through the speed setting dial 42 (the manipulating portion).

Thus, according to the disk grinder 10 of the present embodiment, it is not necessary to provide a transparent window (a light cover) or other such members to the housing 12 in order to see the indicator device (the LED indicator portions 45a and 45b) therethrough. As a result, even when additional LED indicator portions should be provided to the disk grinder 10, the housing 12 can be used as is (i.e., without changing design or size thereof). In addition, the number of components of the disk grinder 10 can be reduced.

In addition, because the LED indicator portions 45a and 45b are attached to the circuit board 29, it is not necessary to provide a special case in order to house the LED indicator portions 45a and 45b therein.

Various changes and modifications may be made to the present invention without departing from the scope of the previously shown and described embodiment. For example, in the embodiment, the speed setting dial 42 is exemplified as the manipulating portion. However, the switch main portion 21b of the electric power switch 21 can be used as the manipulating portion. In such a case, the switch main portion 21b may be formed from the light transmissive (transparent) materials.

Further, in the embodiment, the LED indicator portions 45a and 45b are arranged and constructed to emit the light when the disk grinder 10 is in the power supplied condition and the reactuate preventive condition. However, the LED indicator portions 45a can be arranged and constructed to emit the light when the motor 22 is in an overload condition. Conversely, the LED indicator portions 45b can be arranged and constructed to emit the light when the disk grinder 10 is continuously used for a long time over a predetermined time. In addition, the number of the LED indicator portions 45a and 45b can be changed, if necessary.

Further, in the embodiment, an electrical disk grinder 10 is exemplified as the electrical power tool. However, an electrical drill, an electrical disk saw and other such machines can be used as the electrical power tool.

What is claimed is:

1. An electrical power tool, comprising:
a housing;
a rotating tool that is rotatably attached to the housing;
a motor that is positioned in the housing and is capable of rotating the rotating tool;
a manipulating portion that is attached to the housing; and
an indicator device that is disposed in the housing and is capable of indicating a condition of the electrical power tool,
wherein the manipulating portion is positioned to substantially cover the indicator device, and wherein the manipulating portion is constructed such that light emitted from the indicator device can be transmitted therethrough.

2. The electrical power tool as defined in claim 1, wherein the manipulating portion and the indicator device are attached to a circuit board of a circuit device for controlling the motor.

3. The electrical power tool as defined in claim 2, wherein the manipulating portion is partially projected from a slot that is formed in the housing.

4. The electrical power tool as defined in claim 3, wherein the manipulating portion comprises a speed setting dial that is capable of setting rotation speeds of the motor.

5. The electrical power tool as defined in claim 4, wherein the speed setting dial is rotatably attached to the circuit board while an outer peripheral surface thereof is partially projected from the slot.

6. The electrical power tool as defined in claim 4, wherein the speed setting dial is positioned to substantially encircle the indicator device.
